(19) United States
(12) Patent Application Publication
(10) Pub. No.: US 2005/0123720 A1
(43) Pub. Date: Jun. 9, 2005

(54) Laminate sheet having reinforcement film and method of manufacturing the same

(76) Inventors: Tokuhito Suzuki, Chiba (JP); Takashi Ishida, Chiba (JP); Masahiro Harashige, Chiba (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/006,973

(22) Filed: Dec. 8, 2004

(30) Foreign Application Priority Data
Dec. 9, 2003 (JP) 2003-410205

(51) Int. Cl. B32B 3/10

(52) U.S. Cl. 428/131; 428/137

(57) ABSTRACT

A laminate sheet has a base layer, and a first uniaxially stretched reticular film and a second uniaxially stretched reticular film laminated to the top and back surfaces of the base layer, respectively. Each of the uniaxially stretched reticular films is made of a thermoplastic resin of the same type. The respective uniaxially stretched reticular films are laminated to the base through thermo-compression bonding with their stretching directions oriented perpendicular to each other.

### BACKGROUND OF THE INVENTION

1. Field of the Invention

The present invention relates to a laminate sheet which has a base layer and a reticular reinforcement layer laminated to the base layer, and a method of manufacturing the same.

2. Description of the Related Art

Conventionally, a known wrapping material for use in wrapping an article includes a reinforcement laminated to one or both sides of a base made of paper, film or the like for supplementing the strength of the base. JP-2002-144451-A, for example, discloses a wrapping material which comprises a base made of paper, film or the like, and a reinforcement or a reticular reinforcement made of a thermoplastic resin, laminated to one side of the base by thermo-compression bonding. The reticular reinforcement comprises a pair of uniaxially stretched films, each of which is produced by stretching a film formed with a plurality of slits parallel with one another in a direction parallel with the slits, and expanding the film in a direction perpendicular to the stretching direction. The two films are superimposed on top of another with their stretched directions perpendicular to each other, and are fused together. Such a reticular reinforcement layer, used for reinforcement, provides a laminate sheet which excels in balance of strengths in the longitudinal and transverse directions.

However, since the foregoing conventional laminate sheet has the reticular reinforcement layer laminated to the base through thermo-compression bonding, the laminate sheet can suffer from curling caused by a difference in thermal contraction ratio of the two materials unless the base and reinforcement are made of appropriately selected materials. The curling is not favorable because the resulting laminate sheet becomes more difficult to handle. Also, since the reticular reinforcement layer comprises two uniaxially stretched films fused to each other, the uniaxially stretched film can be adhered to the base over the interface therebetween, whereas the two uniaxially stretched films are partially adhered to each other on the interface therebetween, possibly resulting in a lower adhesion strength depending on the open area ratio of the net.

The laminate sheet can be improved to prevent the curling by laminating the reticular reinforcement layers on both sides of the base. However, since the reticular reinforcement layer per se is in a two-layer structure, the fabrication of the improved laminate sheet results in a large increase in the amount of material used. This leads to an increased cost of the laminate sheet. Also, the increased number of laminated layers causes the resulting laminate sheet to be correspondingly thicker and harder, thereby making the laminate sheet itself unsuitable for applications which require softness. Moreover, even though the reticular reinforcement layers are laminated to both sides of the base, the problem still remains unsolved with respect to the strength with which the uniaxially stretched films are adhered to each other in the reticular reinforcement layer.

The foregoing problem is not limited to the laminate sheet used for a wrapping material, but similarly arises when the laminate sheet is used for house wrapping, agricultural materials, filters, automobile interior materials, industrial materials, and the like.

### SUMMARY OF THE INVENTION

It is an object of the present invention to provide a laminate sheet which prevents the curling without increasing the amount of material used and improves the adhesion strength between respective layers, and a method of manufacturing the laminate sheet.

To achieve the above object, a laminate sheet includes a base layer, a first uniaxially stretched reticular film made of a thermoplastic resin and laminated to top surface of the base layer, and a second uniaxially stretched reticular film made of a thermoplastic material of the same type as the first uniaxially stretched reticular film, and laminated to the back surface of the base layer. In this structure, the first uniaxially stretched reticular film and the second uniaxially stretched reticular film are laminated to the base layer through thermo-compression bonding with their stretching directions oriented perpendicular to each other.

By thus laminating uniaxially stretched reticular films made of a thermoplastic resin of the same type on both sides of a base layer, thermal contraction is equal on the surface side and on the back surface of the base layer during the lamination. From this fact, the resulting laminate sheet excels in balance of strengths in two directions perpendicular to each other, and is free of curling. Moreover, the amount of material used will not be increased as compared with a conventional laminate sheet which has a base layer, and a reticular reinforcement layer composed of two laminated uniaxially stretched reticular films, laminated to the base layer. In addition, since the uniaxially stretched reticular films are not laminated together, there is no interface which suffers from a low adhesion strength due to partial adhesion.

The uniaxially stretched reticular films for use in the present invention is preferably a film formed with a plurality of slits parallel with one another, stretched in the direction in which the slits extend, and expanded in a direction perpendicular to the direction in which the film is stretched.

A method of manufacturing a laminate sheet according to the present invention includes the steps of providing a base layer, and a first and a second uniaxially stretched reticular film each made of a thermoplastic resin of the same type, and superposing the first uniaxially stretched reticular film, the base layer, and the second uniaxially stretched reticular film on one another in this order, while orienting the first uniaxially stretched reticular film and the second uniaxially stretched reticular film with their stretching directions perpendicular to each other, and bonding the first uniaxially stretched reticular film, the base layer, and the second uniaxially stretched reticular film together through thermo-compression bonding. This method requires only a single thermo-compression bonding process to complete the laminate sheet of the present invention described above.

Accordingly, the present invention provides a laminate sheet which is manufactured without increasing the amount of materials used, eliminates the curling, and has an increased adhesion strength of the uniaxially stretched reticular films, as compared with the conventional laminate sheet which employs a reticular reinforcement layer which is comprised of uniaxially stretched reticular films laminated to each other. Particularly, the method of manufacturing a laminate sheet according to the present invention can extremely simply manufacture the laminate sheet only through a single thermo-compression bonding process.

It should be noted that in the present invention, the “longitudinal direction” refers to a machine direction, i.e., a direction in which a laminate sheet, a film or the like is fed when it is manufactured, and the “transverse direction” refers to the direction perpendicular to the longitudinal direction, i.e., a transverse direction of the laminate sheet, film or the like.

The above and other objects, features and advantages of the present invention will become apparent from the following description with reference to the accompanying drawings which illustrate examples of the present invention.

### BRIEF DESCRIPTION OF THE DRAWINGS

FIG. 1 is a cross-sectional view schematically illustrating a laminate sheet according to one embodiment of the present invention;

FIG. 2 is a diagram for describing an exemplary method of manufacturing the laminate sheet illustrated in FIG. 1;

FIG. 3A is a partial perspective view of a uniaxially stretched split-fiber film suitable for use as a reinforcement layer illustrated in FIG. 1;

FIG. 3B is an enlarged perspective view of an end face of the uniaxially stretched split-fiber film illustrated in FIG. 3A;

FIG. 4 is a partial perspective view of an original film for use in manufacturing the uniaxially stretched split-fiber film illustrated in FIG. 3 when it is formed with slits;

FIG. 5 is a partial plan view of the laminate sheet which employs the uniaxially stretched split-fiber film illustrated in FIG. 3 for a reinforcement layer;

FIG. 6A is a partial perspective view of a uniaxially stretched slit film suitable for use as the reinforcement layer illustrated in FIG. 1;

FIG. 6B is an enlarged perspective view of an end face of the uniaxially stretched slit film illustrated in FIG. 6A;

FIG. 7 is a schematic diagram illustrating the configuration of an exemplary laminate sheet manufacturing apparatus according to the present invention; and

FIG. 8 is a schematic diagram illustrating a process for manufacturing a uniaxially stretched split-fiber film.

### DESCRIPTION OF THE PREFERRED EMBODIMENTS

Referring to FIG. 1, there is illustrated a schematic cross-sectional view of laminate sheet 1 according to one embodiment of the present invention which comprises base layer 2, first reinforcement layer 3 laminated to the top or one surface of base layer 2, and second reinforcement layer 4 laminated to the back or the other surface of base layer 2. As is apparent from FIG. 1, base layer 2 is sandwiched by first reinforcement layer 3 and second reinforcement layer 4. First reinforcement layer 3 and second reinforcement layer 4 are both made of the same type of thermoplastic resin, and are laminated to base layer 2 through thermo-compression bonding.

Base layer 2 can be made of any material, including, for example, paper, non-woven fabric, foamed material, metal foil, resin film, wood film, and the like. Which material to select for base layer 2 depends on the characteristics required for base layer 2 in accordance with a particular application of laminate sheet 1. Base layer material 2 can be made of an air-permeable material if air permeability is required, or can be made of a metal foil, a resin film or the like if an air barrier property is required.

First reinforcement layer 3 and second reinforcement layer 4, which provide a required tensile strength to laminate sheet 1, are made of a uniaxially stretched reticular film stretched in one direction, and are laminated to base layer 2 with their directions of stretching oriented perpendicular to each other. Since the uniaxially stretched reticular film is stretched in one direction and is in a reticular structure, the uniaxially stretched reticular film has a high tensile strength in the direction of stretching with a small amount of material. Thus, by laminating the two uniaxially stretched reticular films (first reinforcement layer 3 and second reinforcement layer 4) on base layer 2 with their directions of stretching oriented perpendicular to each other, resulting laminate sheet 1 excels in balance of strengths in the directions perpendicular to each other (for example, the longitudinal direction and transverse direction).

Also, first reinforcement layer 3 and second reinforcement layer 4 are made of the same type of thermoplastic resin, so that even if they are laminated to both sides of base layer 2 through thermo-compression bonding, the thermal contraction ratio on the top surface of base layer 2 is substantially equal to that on the back of the same. Consequently, resulting laminate sheet 1 is free of curling, and therefore will not compromise its own handling, including mechanical workability when it is processed, field workability when it is actually used, and the like.

The uniaxially stretched reticular film, which makes up first reinforcement layer 3 and second reinforcement layer 4, may be made of a single film which forms part of the respective reticular reinforcement layers used in the laminate sheet described also in “DESCRIPTION OF RELATED ART.” As such, even if these reinforcement layers 3, 4 are laminated to both sides of base layer 2, the amount of material used will not be increased, and laminate sheet 1 will not be increased in overall thickness, as compared with the conventional laminate sheet which has a reticular reinforcement sheet laminated to one side of a base layer.

Moreover, in laminate sheet 1 of this embodiment, first reinforcement layer 3 and second reinforcement layer 4, each of which has a net structure, are not laminated to each other, in the conventional laminate sheet, but instead are laminated to base layer 2 which is not in net structure. As a result, reinforcements 3, 4 are entirely bonded to base layer 2. The whole surfaces of reinforcements 3, 4 which face base layers 3, 4, that is interfaces with base layers 3, 4, are bonded to base layer 2, thereby eliminating the interface on which the adhesion strength is poor due to partial adhesion, as found in the conventional laminate sheet. In conclusion, each reinforcement layer 3, 4 will not suffer from a lower adhesion strength. The “net structure” used herein refers to a structure which has at least a plurality of first components that are arranged along a certain direction in parallel with and spaced apart from one another, and a plurality of second components that are arranged along a direction, in which the second components intersect with the first components, in parallel with and spaced apart from one another, and is formed with apertures surrounded by the first components and second components. Therefore, while paper, for example, may be microscopically regarded as a net structure because it has apertures, the paper is not included in the “net structure” herein defined because of its random fiber directions.

As described above, laminate sheet 1 is highly advantageous over the conventional laminate sheet, and are suitable for use in a variety of applications, including wrapping materials, house wrapping, agricultural materials, filters, automobile interior materials, industrial materials, and the like.

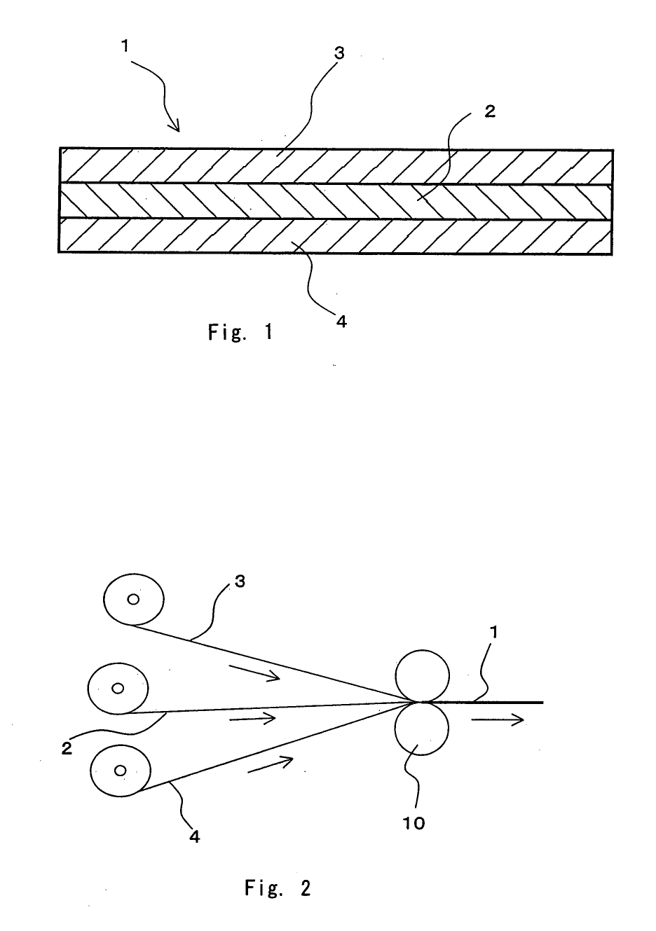

Now, a general procedure of manufacturing laminate sheet 1 will be described with reference to FIG. 2.

As illustrated in FIG. 2, elongated base layer 2, first reinforcement layer 3, and second reinforcement layer 4 have been prepared in advance as wound in rolls. When first reinforcement layer material 3 is made of a uniaxially stretched reticular film stretched in a longitudinal direction, second reinforcement layer 4 is made of a uniaxially stretched reticular film stretched in a transverse direction. Alternatively, when first reinforcement layer 3 is made of a uniaxially stretched reticular film stretched in the transverse direction, second reinforcement layer 4 is made of a uniaxially stretched reticular film stretched in the longitudinal direction.

Then, these base layer 2, first reinforcement layer 3, and second reinforcement layer 4 are fed out from the rolls such that they are superimposed on one another in the order of first reinforcement layer 3, base layer 2, and second reinforcement layer 4, i.e., base layer 2 is sandwiched between first reinforcement layer 3 and second reinforcement layer 4, and are supplied between a pair of thermo-compression bonding rollers 10. Thermo-compression bonding rollers 10 have been heated to a temperature equal to or higher than the melting point (or softening point) of the thermoplastic resin which makes up first reinforcement layer 3 and second reinforcement layer 4. As base layer 2, first reinforcement layer 3, and second reinforcement layer 4, which are superimposed on one another in the aforementioned order, are passed between thermo-compression bonding rollers 10, first reinforcement layer 3 and second reinforcement layer 4 are thermally and compressively bonded onto both surfaces of base layer 2 to produce laminate sheet 1.

During the thermo-compression bonding of base layer 2 with respective reinforcement layers 3, 4, the adhesion strength is enhanced if their bonding surfaces have undergone such preprocessing as corona processing, ozone processing, or a frame processing. This method is effective particularly when layers made of different materials are laminated. It is believed that such preprocessing provides a polar group on the surfaces, which are to be bonded together, to enhance the adhesive force.

Resulting laminate sheet 1 is cut in predetermined dimensions, or wound up in rolls depending on its application.

As described above, laminate sheet 1 can be manufactured through a single thermo-compression bonding process by simultaneously supplying base layer 2, first reinforcement layer 3, and second reinforcement layer 4 between thermo-compression bonding rollers 10. On the other hand, a conventional laminate sheet which uses a reticular reinforcement layer, involves the thermo-compression bonding process twice, one for making a reticular reinforcement layer from two uniaxially stretched reticular films, and one for adhering the reticular reinforcement layer to the base layer. In this embodiment, in turn, laminate sheet 1 can be more simply produced through a single thermo-compression bonding process at a lower cost because the thermo-compression bonding process is required a less number of times than the conventional laminate sheet.

Having described laminate sheet 1 above, detailed description will now be given on the uniaxially stretched reticular film suitable for use as respective reinforcement layer materials 3, 4 of laminate sheet 1.

The uniaxially stretched reticular film is produced by forming a film made of a thermoplastic resin with a multiplicity of slits extending in parallel with one another, stretching the film in a direction in which the slits extend, and then expanding the film in a direction perpendicular to the direction in which the film has been stretched, or by stretching a film made of a thermoplastic resin in one direction, forming a multiplicity of slits in parallel with the direction in which the film has been stretched, and expanding the resulting film in a direction perpendicular to the stretching direction. Uniaxially stretched reticular films are roughly classified into a uniaxially stretched split-fiber film and a uniaxially stretched slit film. The following description will focus on the uniaxially stretched split-fiber film and uniaxially stretched slit film.

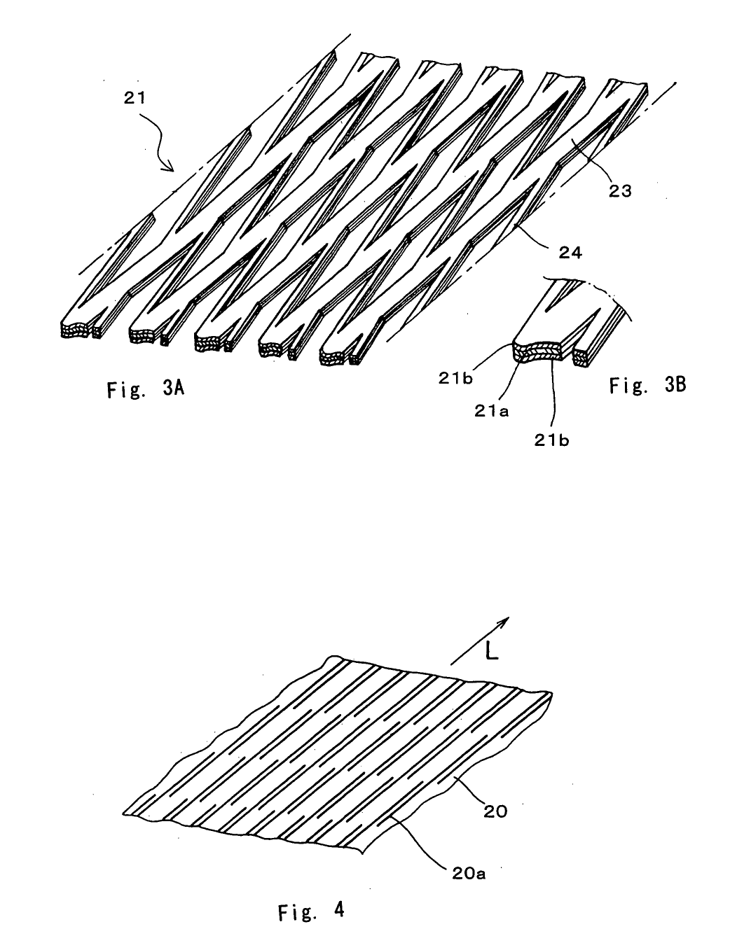

As illustrated in FIG. 3B, uniaxially stretched split-fiber film 21 has a laminate structure composed of layer 21a made of a first thermoplastic resin, and layers 21b laminated to both sides of layer 21a. Layers 21b are made of a second thermoplastic resin which has a lower melting point than the first thermoplastic resin. As illustrated in FIG. 3A, uniaxially stretched split-fiber film 21 comprises a plurality of trunk fibers 23 extending in parallel with one another, and branch fibers 24 intersecting with truck fibers 23 to connect adjacent trunk fibers 23 to each other. Branch fibers 24 are thinner than trunk fibers 23, so that the mechanical strength of uniaxially stretched split-fiber film 21 is mainly given by trunk fibers 23.

Each layer 21b made of the second thermoplastic resin has a thickness smaller by 50% or less, and preferably 40% or less, than the overall thickness of uniaxially stretched split-fiber film 21. For satisfying a variety of properties of uniaxially stretched split-fiber film 21 such as an adhesion strength and the like during the thermo-compression bonding, the thickness of layer 21b made of the second thermoplastic resin may be 5 μm or more, but is preferably selected from a range of 10 to 100 μm.

A method of manufacturing uniaxially stretched split-fiber film 21 may be carried out, for example, in the following manner.

First, original film 20 in a three-layer structure having layers 21b, each made of the second thermoplastic resin, laminated to both sides of layer 21a made of the first thermoplastic resin is manufactured by extrusion molding such as a multilayer inflation method, a multilayer T-die method, or the like. Then, this original film 20 is stretched in a longitudinal direction (direction indicated by arrow L in FIG. 4) and is formed with a multiplicity of cross-stitched parallel slits 20a in the longitudinal direction by a splitting process using a splitter or by a slitting process using hot blades. Then, original film 4 formed with slits 20a is widened in a direction perpendicular to the direction in which slits 20a extend. In this way, uniaxially stretched split-fiber film 21 is produced, as illustrated in FIG. 3, wherein trunk fibers 23 are aligned substantially in the longitudinal direction.

A stretching magnification (orientation magnification) of film 21 is preferably 1.1 to 15 times, and more preferably 3 to 10 times. When the stretching magnification is less than 1.1 times, the mechanical strength of the film would be insufficient. On the other hand, when the stretching magnification exceeds 15 times, it becomes difficult to stretch the film by an ordinary method, and such a problem arises in which an expensive machine for the stretching operation is required. The stretching is preferably performed at multiple stages in order to prevent an unevenly stretched film.

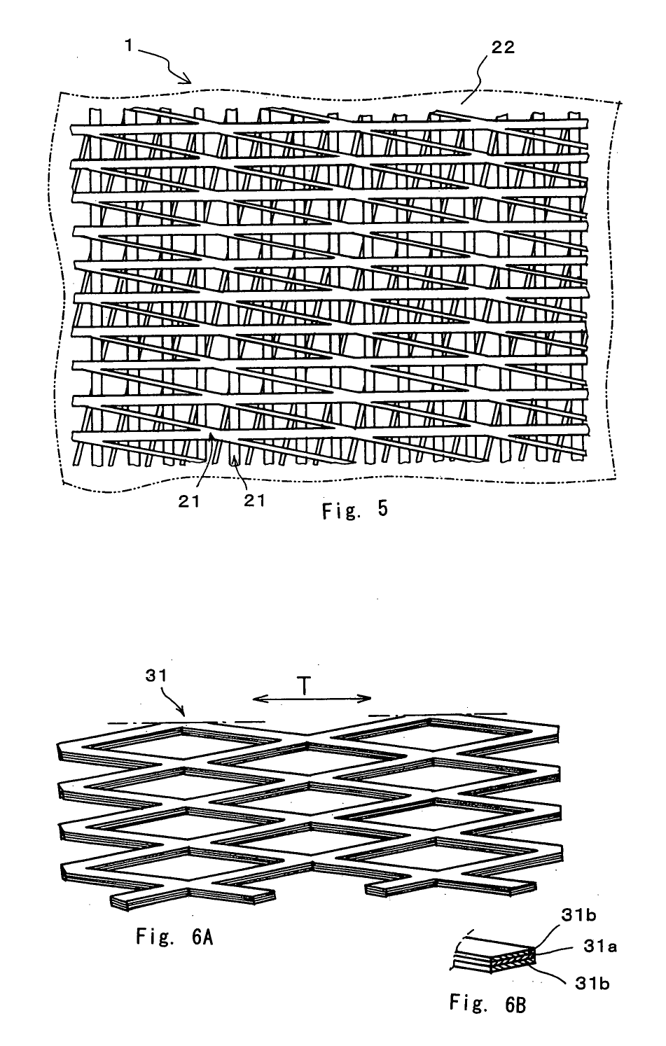

Uniaxially stretched split-fiber films 12 fabricated in the foregoing manner are bonded on both sides of base layer 2 (see FIG. 1) through thermo-compression bonding such that trunk fibers 23 of one film are perpendicular to trunk fibers 23 of the other film. The thermo-compression bonding should be performed at a temperature equal to or lower than the melting point of the first thermoplastic resin and equal to or higher than the melting point of the second thermoplastic resin so as not to lose the stretching effect of layer 21a made of the first thermoplastic resin. FIG. 5 illustrates a plan view of laminate sheet 1 using uniaxially stretched split-fiber film 21. FIG. 5 illustrates laminate sheet 1 through base layer 22 in order to show the reticular structure of two uniaxially stretched split-fiber films 21. Actually, base layer 22 is sandwiched between two uniaxially stretched split-fiber films 21.

When uniaxially stretched split-fiber films 21 illustrated in FIG. 3A is used for reinforcement layers 3, 4 illustrated in FIG. 1, one of uniaxially stretched split-fiber films 21 can be supplied as it is on base layer 22, whereas the other one must be cut into tile-shaped pieces, each of which has a length equal to the width of laminate sheet 1 to be manufactured, such that the tile-shaped film pieces are supplied intermittently in a direction perpendicular to the direction in which base layer 22 is supplied, in order that trunk fibers 23 of one uniaxially stretched split-fiber films 21 are made perpendicular to trunk fibers 23 of the other uniaxially stretched split-fiber film 21. For this reason, laminate sheet 1 illustrated in FIG. 5 includes joints of tile-shaped uniaxially stretched split-fiber film 21 at regular intervals.

Next described will be the uniaxially stretched slit film.

FIG. 6A illustrates uniaxially stretched slit film 31. Uniaxially stretched slit film 31 can be made from an original film which has the same structure as that used for manufacturing uniaxially stretched split-fiber film 21 illustrated in FIG. 3A. Specifically, as illustrated in FIG. 6B, uniaxially stretched slit film 31 comprises layer 31a made of a first thermoplastic resin, and layers 31b laminated to both sides of layer 31a. Each layer 31b is made of a second thermoplastic resin which has a melting point lower than the first thermoplastic resin. Then, the original film is formed with cross-stitched slits in the transverse direction (a direction indicated by arrow T in FIG. 6A) in a slitting process, and the resulting film is stretched in the transverse direction such that cross-stitched slits are opened in the longitudinal direction. This results in reticular uniaxially stretched slit film 31. Though joints are formed as is the case with uniaxially stretched split-fiber film 21, uniaxially stretched slit films 31 illustrated in FIG. 6A may be placed to sandwich a base layer such that their stretching directions are perpendicular to each other to produce a laminate sheet.

When a laminate sheet formed with joints is not desirable, uniaxially stretched split-fiber film 21 illustrated in FIG. 3A may be combined with uniaxially stretched slit film 31 illustrated in FIG. 6A to form a structure in which a base layer is sandwiched by uniaxially stretched split-fiber film 21 and uniaxially stretched slit film 31. In this way, uniaxially stretched split-fiber film 21 and uniaxially stretched slit film 31 are continuously supplied, while they are placed on the top and back surfaces of the base layer, respectively, and the three components are bonded together through thermo-compression bonding to provide joint-less laminate sheet 1 (FIG. 1).

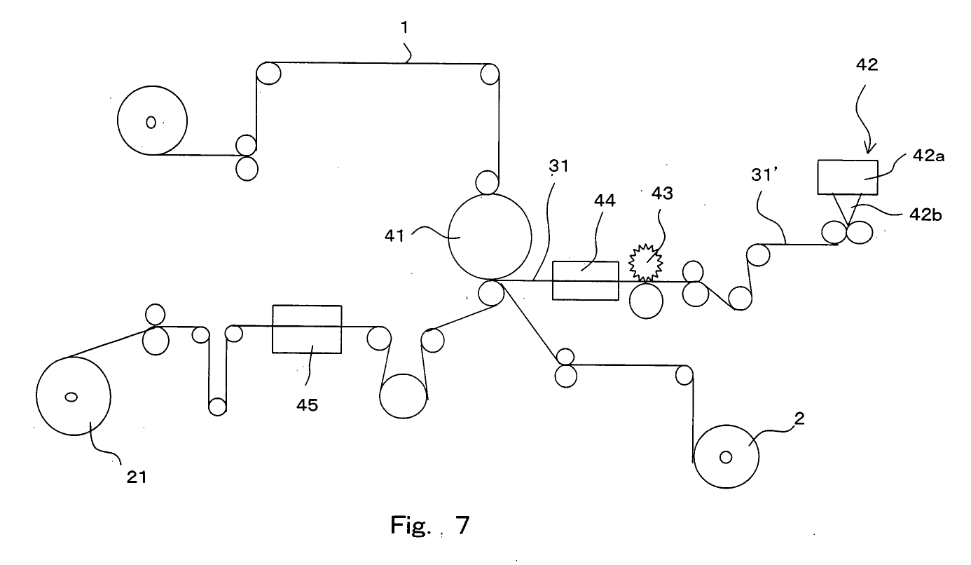

Next, an exemplary method of manufacturing a laminate sheet will be described with reference to FIG. 7 when uniaxially stretched split-fiber film 21 and uniaxially stretched slit film 31 are used for the reinforcement layers, respectively, on one and the other sides of the base layer.

FIG. 7 illustrates an exemplary laminate sheet manufacturing apparatus according to the present invention. In the example illustrated in FIG. 7, base layer 2 and uniaxially stretched split-fiber film 21 have been in advance provided in rolls, and they are supplied to a manufacturing line for manufacturing uniaxially stretched slit film 31 to manufacture laminate sheet 1.

Multilayer film manufacturing machine 42 has multilayer extruder 42a and die 42b for manufacturing original film 31′ in three-layer structure, as illustrated in FIG. 6B. Die 42b used herein may be either for the multilayer inflation method or for the multilayer T-die method. Original film 31′ manufactured by multilayer film manufacturing machine 42 is formed with transverse slits by force-cutting slit forming roller 43, while it is conveyed by rollers, and is further stretched in the transverse direction by transverse stretcher 44 to provide uniaxially stretched slit film 31. Uniaxially stretched slit film 31 thus manufactured is supplied to thermo-compression bonding rollers 41.

Uniaxially stretched split-fiber film 21, after formed with longitudinal slits, is wound in a roll form before it is widened in the transverse direction. Uniaxially stretched split-fiber film 21, before being widened, is fed out from the roll, and widened by spreader 45 in the transverse direction. Widened uniaxially stretched split-fiber film 21 is superimposed on uniaxially stretched slit film 31, and they are supplied together to thermo-compression bonding rollers 41.

When uniaxially stretched split-fiber film 21 and uniaxially stretched slit film 31 are supplied to thermo-compression bonding roller 41, base layer 2 is supplied between uniaxially stretched split-fiber film 21 and uniaxially stretched slit film 31. Therefore, uniaxially stretched split-fiber film 21, base layer 2, and uniaxially stretched slit film 31 are superimposed on one another in this order before they are supplied between thermo-compression bonding rollers 41. These components are bonded together by thermo-compression bonding rollers 41 through thermo-compression bonding. As a result, uniaxially stretched split-fiber film 21 and uniaxially stretched slit film 31 are entirely bonded to base layer 2, thereby fabricating laminate sheet 1. Resulting laminate sheet 1 can be wound in a roll form.

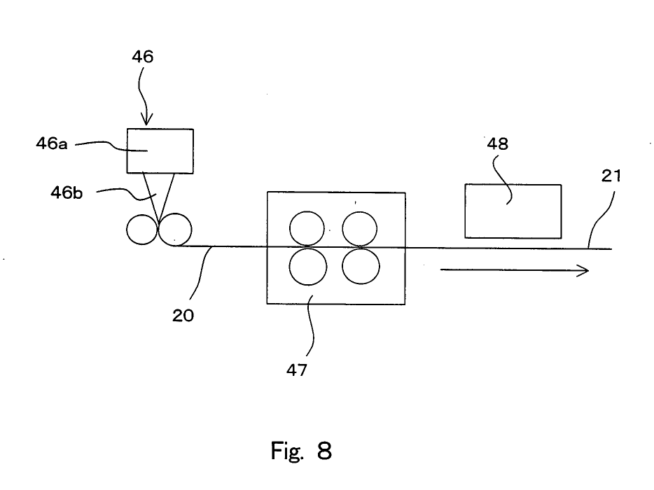

In the exemplary method shown in FIG. 7, uniaxially stretched split-fiber film 21 has already been formed with slits before it is provided. Alternatively, uniaxially stretched split-fiber film 21 may be started with the manufacturing of a film, in a manner similar to uniaxially stretched slit film 31. In this event, uniaxially stretched split-fiber film 21 wound in a roll form, shown in FIG. 7, is replaced with a process illustrated in FIG. 8. Specifically, the aforementioned original film 20 in three-layer structure is formed by multilayer film manufacturing machine 46 having multilayer extruder 46a and die 46b. Next, original film 20 is stretched in the longitudinal direction by longitudinal stretcher 47. Stretched original film 20 is formed with longitudinal slits by splitter 48, and subsequently is widened in the transverse direction by spreader 45 shown in FIG. 7, and supplied to thermo-compression bonding rollers 41.

When uniaxially stretched split-fiber film 21 and uniaxially stretched slit film 31 are used for first reinforcement layer 3 and second reinforcement layer 4, respectively, as mentioned above, the manufacturing of uniaxially stretched split-fiber film 21 and uniaxially stretched slit film 31 can be directly followed by in-line manufacturing of laminate sheet 1. In other words, laminate sheet 1 can be manufactured through a process continuous to the manufacturing of respective reinforcement layers 3, 4. This can further simplify the manufacturing process of laminate sheet 1, and as a result, provide laminate sheet 1 at a lower cost.

The resin used for making uniaxially stretched split-fiber film 21 and uniaxially stretched slit film 31 may be, for example, one of substances including polyolefin such as polyethylene and polypropylene, copolymer of these substances, polyester such as polyethyleneterephthalate and polybutyleneterephthalate, copolymer of these substances, polyamide such as nylon 6 and nylon 66, copolymer of these substances, polyvinyl chloride, methacrylic acid or polymer and copolymer of the derivative of methacrylic acid, polystyrene, polysulfone, polytetrachloroethylenepolycarbonate, and polyurethane. Among others, polyolefin, copolymer thereof, polyester, and copolymer thereof are preferred because they are easily subjected to the split-fiber processing.

Although certain preferred embodiments of the present invention have been shown and described in detail, it should be understood that various changes and modifications may be made without departing from the spirit or scope of the appended claims.

1. A laminate sheet comprising:
a base layer;
a first uniaxially stretched reticular film made of a thermoplastic resin and laminated to a top surface of said base layer; and
a second uniaxially stretched reticular film made of a thermoplastic material of the same type as said first uniaxially stretched reticular film, and laminated to a back surface of said base layer,
wherein said first uniaxially stretched reticular film and said second uniaxially stretched reticular film are laminated to said base layer through thermo-compression bonding while said first and second uniaxially stretched reticular films are stretched in directions perpendicular to each other.

2. The laminate sheet according to claim 1, wherein said first and second uniaxially stretched reticular films are equal in thermal contraction ratio.

3. The laminate sheet according to claim 1, wherein the whole surfaces of said first and second uniaxially stretched reticular films which face said base layer are bonded to said base layer.

4. The laminate sheet according to claim 1, wherein said first and second uniaxially stretched reticular films each comprise a plurality of first components arranged along a particular direction in parallel with and spaced apart from one another, a plurality of second components arranged along a direction intersecting with said first components in parallel with and spaced apart from one another, and openings each surrounded by said first and second components.

5. The laminate sheet according to claim 1, wherein said first and second uniaxially stretched reticular films each have a three-layer structure composed of a layer made of a first thermoplastic resin, and layers made of a second thermosetting resin and laminated to both sides of said layer, said second thermoplastic resin having a melting point lower than said first thermoplastic material.

6. The laminate sheet according to claim 5, wherein at least one of said first and second uniaxially stretched reticular films is a uniaxially stretched split-fiber film, said uniaxially stretched split-fiber film being fabricated by stretching said original three-layer structure film in a longitudinal direction, forming a plurality of longitudinal slits in said stretched original film, and widening said original film in a transverse direction.

7. The laminate sheet according to claim 5, wherein at least one of said first and second uniaxially stretched reticular films is a uniaxially stretched slit film, said uniaxially stretched slit film being fabricated by forming a plurality of transverse slits in said original three-layer structure film, and stretching said original film formed with the slits in a transverse direction to open the slits in the longitudinal direction.

8. The laminate sheet according to claim 5, wherein:
said first uniaxially stretched reticular film is a uniaxially stretched split-fiber film, said uniaxially stretched split-fiber film being fabricated by stretching said original three-layer structure film in a longitudinal direction, forming a plurality of longitudinal slits in said stretched original film, and widening said original film in a transverse direction; and
said second uniaxially stretched reticular film is a uniaxially stretched slit film, said uniaxially stretched slit film being fabricated by forming a plurality of transverse slits in said original three-layer structure film, and stretching said original film formed with the slits in the transverse direction to open the slits in the longitudinal direction.

9. The laminate sheet according to claim 1, wherein said base layer is air permeable.

10. The laminate sheet according to claim 1, wherein said base layer has an air barrier property.

11. A method of manufacturing a laminate sheet, comprising the steps of:
providing a base layer, and a first and a second uniaxially stretched reticular film each made of a thermoplastic resin of the same type; and
superposing said first uniaxially stretched reticular film, said base layer, and said second uniaxially stretched reticular film on one another in this order, while orienting said first uniaxially stretched reticular film and said second uniaxially stretched reticular film with their stretching directions perpendicular to each other, and bonding said first uniaxially stretched reticular film, said base layer, and said second uniaxially stretched reticular film together through thermo-compression bonding.

12. The method of manufacturing a laminate sheet according to claim 11, wherein said step of providing a base and uniaxially stretched reticular films comprises:
forming a first original film with a plurality of transverse slits, stretching said first original film formed with the transverse slits in a transverse direction to open the transverse slits in the longitudinal direction to form a uniaxially stretched slit film as said first uniaxially stretched reticular film; and
providing a longitudinally stretched uniaxially stretched split-fiber film as said second uniaxially stretched reticular film.

13. The method of manufacturing a laminate sheet according to claim 12, wherein said step of providing a uniaxially stretched split-fiber film comprises:
stretching a second original film in the longitudinal direction, forming said stretched first original film with a plurality of longitudinal slits, and further widening said second original film to form said uniaxially stretched split-fiber film.

14. The method of manufacturing a laminate sheet according to claim 12, wherein said step of superposing said first uniaxially stretched reticular film, said base, and said second uniaxially stretched reticular film on one another comprises:
continuously supplying said uniaxially stretched split-fiber film and said uniaxially stretched slit film onto a top and back surfaces of said base layer, respectively.
